(19) United States
(12) Patent Application Publication
(10) Pub. No.: US 2026/0229655 A1
(43) Pub. Date: Aug. 6, 2026

(54) SECONDARY BATTERY MODULE

(71) Applicant: Prime Planet Energy & Solutions, Inc., Tokyo (JP)

(72) Inventor: Daiki WATANABE, Kakogawa-shi (JP)

(21) Appl. No.: 19/530,349

(22) Filed: Feb. 5, 2026

(30) Foreign Application Priority Data
Feb. 6, 2025 (JP) 2025-018487

(51) Int. Cl. H01M 50/133; H01M 10/613; H01M 10/647; H01M 10/653; H01M 10/6554; H01M 10/6556; H01M 50/103; H01M 50/209; H01M 50/342

(52) U.S. Cl. CPC H01M 50/133; H01M 10/613; H01M 10/647; H01M 10/653; H01M 10/6554; H01M 10/6556; H01M 50/103; H01M 50/209; H01M 50/3425; H01M 2200/20

(57) ABSTRACT

In a first state of each of a plurality of batteries in a secondary battery module, an electrode assembly has a first thickness in a first direction, and in a second state of each of the plurality of batteries, the electrode assembly has a second thickness in the first direction, the second thickness is larger than the first thickness by a thickness of 1.5% or more of a dimension of the first surface in the first direction, a first plate thickness of the case is larger than a second plate thickness of the case, a first corner portion of the case has a first curvature radius, a second corner portion of the case has a second curvature radius, and each of the first curvature radius and the second curvature radius is 0.5 mm or less.

### CROSS REFERENCE TO RELATED APPLICATIONS

This nonprovisional application is based on Japanese Patent Application No. 2025-018487 filed on Feb. 6, 2025, with the Japan Patent Office, the entire contents of which are hereby incorporated by reference.

### BACKGROUND OF THE INVENTION

### Field of the Invention

The present technology relates to a secondary battery module.

### Description of the Background Art

An exemplary temperature control mechanism for a secondary battery is described in Japanese National Patent Publication No. 2022-540234.

### SUMMARY OF THE INVENTION

It is required to efficiently perform temperature control of a secondary battery. It is required to maintain high heat conductivity between the battery and a temperature control member even when an electrode assembly is expanded and contracted due to charging and discharging of the battery to cause deformation of a case that accommodates the electrode assembly. From this viewpoint, a conventional temperature control mechanism still has room for improvement.

An object of the present technology is to provide a secondary battery module to perform efficient temperature control.

The present technology provides the following secondary battery module.

[1] A secondary battery module comprising: a plurality of batteries each including an electrode assembly and a case that accommodates the electrode assembly, the case having a prismatic shape, the plurality of batteries being arranged in a first direction; a temperature control member that controls a temperature of each of the plurality of batteries; and a heat transfer layer sandwiched between each of the plurality of batteries and the temperature control member in a second direction orthogonal to the first direction, wherein the case has a first surface extending in a direction orthogonal to the second direction, having at least a portion in contact with the heat transfer layer, and having a first plate thickness, a second surface extending in a direction orthogonal to the first surface and having a second plate thickness, a third surface extending parallel to the second surface and facing the second surface in the first direction, a first corner portion provided between the first surface and the second surface in an outer surface of the case, and a second corner portion provided between the first surface and the third surface in the outer surface of the case, in a first state of each of the plurality of batteries, the electrode assembly has a first thickness in the first direction, and in a second state of each of the plurality of batteries, the electrode assembly has a second thickness in the first direction, and the second thickness is larger than the first thickness by a thickness of 1.5% or more of a dimension of the first surface in the first direction, the first plate thickness of the case is larger than the second plate thickness, and the first corner portion of the case has a first curvature radius, the second corner portion has a second curvature radius, and each of the first curvature radius and the second curvature radius is 0.5 mm or less.

[2] The secondary battery module according to [1], wherein the first plate thickness is smaller than a thickness twice as large as the second plate thickness.

[3] The secondary battery module according to [1] or [2], wherein an inner surface of the first surface and the electrode assembly are separated from each other by 30% or more of the first plate thickness in the second direction.

[4] The secondary battery module according to any one of [1] to [3], wherein the case includes a case main body having a tubular shape, the case main body including the first surface to the third surface, the case main body being provided with a first opening and a second opening at both ends in a third direction orthogonal to the first direction and the second direction, and a first sealing plate and a second sealing plate that seal the first opening and the second opening respectively.

[5] The secondary battery module according to [4], wherein the first surface of the case has a dimension of 300 mm or more in the third direction.

[6] The secondary battery module according to any one of [1] to [5], wherein the electrode assembly is a stacked type electrode assembly in which a positive electrode and a negative electrode are stacked with a separator being interposed between the positive electrode and the negative electrode.

[7] The secondary battery module according to any one of [1] to [6], wherein the heat transfer layer is disposed at a position including a center of the first surface in the first direction.

[8] The secondary battery module according to any one of [1] to [7], wherein each of the first curvature radius and the second curvature radius is 0.2% or more of the dimension of the first surface in the first direction.

[9] The secondary battery module according to any one of [1] to [8], wherein a gas-discharge valve is provided in the first surface of the case.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view showing a configuration of a secondary battery according to one embodiment.

FIG. 2 is a diagram showing a state in which the secondary battery shown in FIG. 1 is viewed in a direction of arrow II.

FIG. 3 is a diagram showing a state in which the secondary battery shown in FIG. 1 is viewed in a direction of arrow III.

FIG. 4 is a front cross sectional view of the secondary battery shown in FIG. 1.

FIG. 5 is a front view showing a negative electrode plate.

FIG. 6 is a front view showing a positive electrode plate.

FIG. 7 is a diagram showing a configuration of a battery module.

FIG. 8 is a cross sectional view showing a bottom portion of a case in a first state of the secondary battery according to one embodiment.

FIG. 9 is a cross sectional view showing the bottom portion of the case in a second state of the secondary battery according to one embodiment.

FIG. 10 is a cross sectional view showing a bottom portion of a case in a second state of a secondary battery according to a comparative example.

FIG. 11 is a diagram for illustrating a method of calculating the thickness of an electrode assembly.

FIG. 12 is a diagram showing arrangements of a heat transfer layer and a gas-discharge valve at the bottom surface of the case.

FIG. 13 is a cross sectional view of a secondary battery to show a structure of an electrode assembly and an arrangement of a gas-discharge valve.

FIG. 14 is a front cross sectional view of a battery module according to a modification.

### DESCRIPTION OF THE PREFERRED EMBODIMENTS

Hereinafter, embodiments of the present technology will be described. It should be noted that the same or corresponding portions are denoted by the same reference characters, and may not be described repeatedly.

It should be noted that in the embodiments described below, when reference is made to number, amount, and the like, the scope of the present technology is not necessarily limited to the number, amount, and the like unless otherwise stated particularly. Further, in the embodiments described below, each component is not necessarily essential to the present technology unless otherwise stated particularly. Further, the present technology is not limited to one that necessarily exhibits all the functions and effects stated in the present embodiment.

It should be noted that in the present specification, the terms “comprise”, “include”, and “have” are open-end terms. That is, when a certain configuration is included, a configuration other than the foregoing configuration may or may not be included.

Also, in the present specification, when geometric terms and terms representing positional/directional relations are used, for example, when terms such as “parallel”, “orthogonal”, “obliquely at 45°”, “coaxial”, and “along” are used, these terms permit manufacturing errors or slight fluctuations. In the present specification, when terms representing relative positional relations such as “upper side” and “lower side” are used, each of these terms is used to indicate a relative positional relation in one state, and the relative positional relation may be reversed or turned at any angle in accordance with an installation direction of each mechanism (for example, the entire mechanism is reversed upside down).

Moreover, sizes such as width, length, and diameter of each member illustrated in the present specification are not limited to those shown in the figures, and can be appropriately changed. In the present specification, ordinal numbers such as “first” and “second” may be given to respective configurations, but these ordinal numbers do not limit priority, order, or the like unless explicitly defined.

In the present specification, the term “battery” is not limited to a lithium ion battery, and may include other batteries such as a nickel-metal hydride battery and a sodium-ion battery. In the present specification, the term “electrode” may collectively represent a positive electrode and a negative electrode. Further, the term “electrode plate” may collectively represent a positive electrode plate and a negative electrode plate.

In the present specification, the “battery” can be mounted on vehicles such as a hybrid electric vehicle (HEV), a plug-in hybrid electric vehicle (PHEV), and a battery electric vehicle (BEV). It should be noted that the use of the “battery” is not limited to the use in a vehicle.

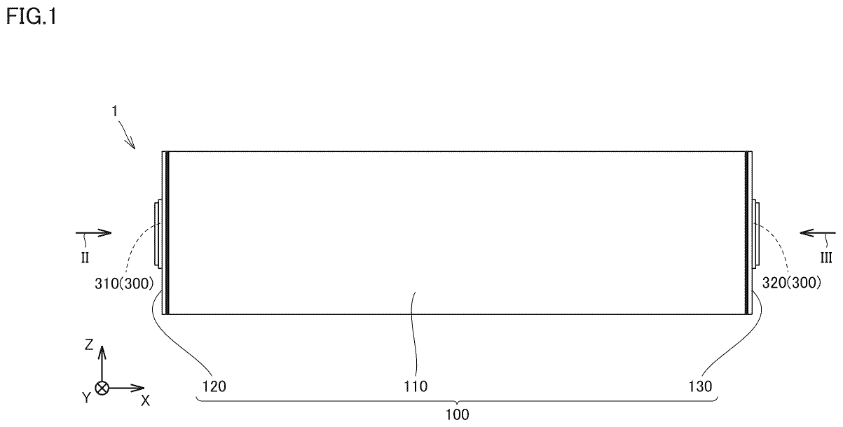

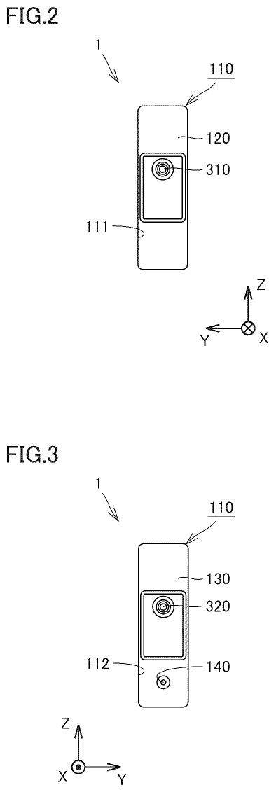

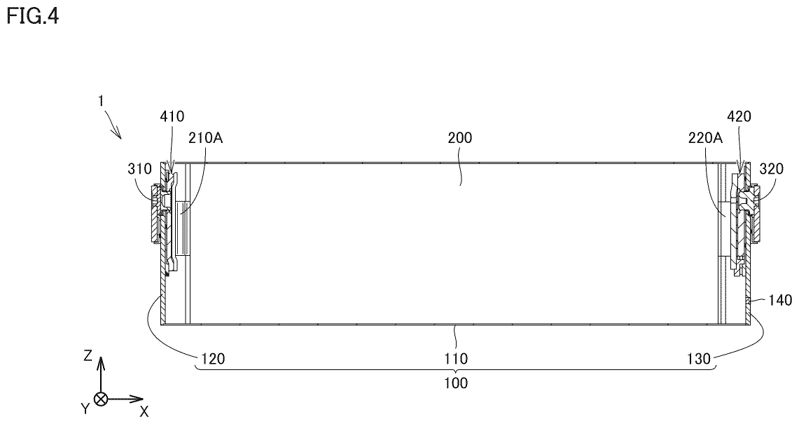

FIG. 1 is a front view of a secondary battery 1 according to one embodiment. FIGS. 2 and 3 are diagrams showing states in which secondary battery 1 (non-aqueous electrolyte secondary battery) shown in FIG. 1 is viewed in a direction of arrow II and a direction of arrow III, respectively. FIG. 4 is a front cross sectional view of secondary battery 1 shown in FIG. 1.

As shown in FIGS. 1 to 4, secondary battery 1 includes a case 100, an electrode assembly 200, electrode terminals 300, and current collectors 400. Case 100 includes a case main body 110, a sealing plate 120, and a sealing plate 130.

When forming a battery module (battery assembly) including secondary battery 1, a plurality of secondary batteries 1 are stacked in the thickness direction of each of the plurality of secondary batteries 1. Secondary batteries 1 stacked may be restrained in the stacking direction (Y direction) by a restraint member, or the battery assembly may be directly supported by a side surface of a case of a battery pack without using the restraint member.

Case main body 110 is constituted of a member having a prismatic tubular shape. Thus, secondary battery 1 having a prismatic shape is obtained. Case main body 110 is composed of a metal. Specifically, case main body 110 is composed of aluminum, an aluminum alloy, iron, an iron alloy, or the like. Case main body 110 is preferably composed of aluminum or an aluminum alloy, and is more preferably composed of A3003H or the like, for example.

As shown in FIG. 1, sealing plate 120 and sealing plate 130 are provided at respective end portions of the case main body. Case main body 110 may be formed into a prismatic tubular shape by a drawing process or the like, for example. However, case main body 110 having the prismatic tubular shape may be formed by bending a plate-shaped member. Each of the corners of the “prismatic tubular shape” may have a shape with a curvature.

In the present embodiment, case main body 110 is formed to be longer in the width direction (X direction: third direction) of secondary battery 1 than in each of the thickness direction (Y direction: first direction) and the height direction (Z direction: second direction) of secondary battery 1.

Case main body 110 includes a pair of long side surfaces and a pair of short side surfaces. The pair of long side surfaces and the pair of short side surfaces are provided to intersect (to be substantially orthogonal to) each other. The pair of long side surfaces and the pair of short side surfaces are connected at their respective end portions. Each of the pair of long side surfaces has an area larger than that of each of the pair of short side surfaces.

### As shown in FIG. 2, an opening 111 (first opening) is provided at an end portion

of case main body 110 on one side in the X direction. Opening 111 is sealed by sealing plate 120 (first sealing plate). Each of opening 111 and sealing plate 120 has a substantially rectangular shape in which the Y direction corresponds to its short-side direction and the Z direction corresponds to its long-side direction. It should be noted that the substantially rectangular shape includes a rectangular shape or a generally rectangular shape such as a rectangular shape having corners each with a curvature. A negative electrode terminal 310 is provided on sealing plate 120. The position of negative electrode terminal 310 can be appropriately changed.

As shown in FIG. 3, an opening 112 (second opening) is provided at an end portion of case main body 110 on the other side in the X direction. Opening 112 is located at an end portion opposite to opening 111, and openings 111, 112 face each other in the X direction. Opening 112 is sealed by sealing plate 130 (second sealing plate). Each of opening 112 and sealing plate 130 has a substantially rectangular shape in which the Y direction corresponds to its short-side direction and the Z direction corresponds to its long-side direction. Sealing plate 130 is provided with a positive electrode terminal 320 and an injection hole 140. The positions of positive electrode terminal 320 and injection hole 140 can be appropriately changed.

Each of sealing plate 120 and sealing plate 130 is composed of a metal. Specifically, each of sealing plate 120 and sealing plate 130 is composed of aluminum, an aluminum alloy, iron, an iron alloy, or the like.

Negative electrode terminal 310 is electrically connected to a negative electrode of electrode assembly 200. Negative electrode terminal 310 is attached to sealing plate 120, i.e., case 100. Positive electrode terminal 320 is electrically connected to a positive electrode of electrode assembly 200. Positive electrode terminal 320 is attached to sealing plate 130, i.e., case 100.

Negative electrode terminal 310 is composed of a conductive material (more specifically, a metal), and can be composed of copper, a copper alloy, or the like, for example. A portion or layer composed of aluminum or an aluminum alloy may be provided at a portion of an outer surface of negative electrode terminal 310.

Positive electrode terminal 320 is composed of a conductive material (more specifically, a metal), and can be composed of aluminum, an aluminum alloy, or the like, for example.

Injection hole 140 is sealed by a sealing member (not shown). As the sealing member, for example, a blind rivet or another metal member can be used.

As shown in FIG. 4, case 100 accommodates electrode assembly 200. Electrode assembly 200 is accommodated in case 100 such that the long-side direction thereof is parallel to the X direction. Electrode assembly 200 is accommodated in case 100 together with the electrolyte solution. Electrode assembly 200 may be obtained by stacking a plurality of electrode assemblies. Electrode assembly 200 includes a main body portion having a substantially rectangular shape, a negative electrode tab group 210A, and a positive electrode tab group 220A.

The main body portion of electrode assembly 200 is constituted of a below-described negative electrode plate 210 (negative electrode), a below-described positive electrode plate 220 (positive electrode), and a below-described separator. Each of negative electrode tab group 210A and positive electrode tab group 220A is formed to protrude from the main body portion of electrode assembly 200 toward sealing plate 120 or sealing plate 130.

Current collectors 400 include a negative electrode current collector 410 and a positive electrode current collector 420. Electrode assembly 200 is electrically connected to negative electrode terminal 310 and positive electrode terminal 320 through current collectors 400.

Negative electrode current collector 410 is disposed on sealing plate 120 with an insulating member composed of a resin being interposed therebetween. Negative electrode current collector 410 is electrically connected to negative electrode tab group 210A and negative electrode terminal 310.

Positive electrode current collector 420 is disposed on sealing plate 130 with an insulating member composed of a resin being interposed therebetween. Positive electrode current collector 420 is electrically connected to positive electrode tab group 220a and positive electrode terminal 320.

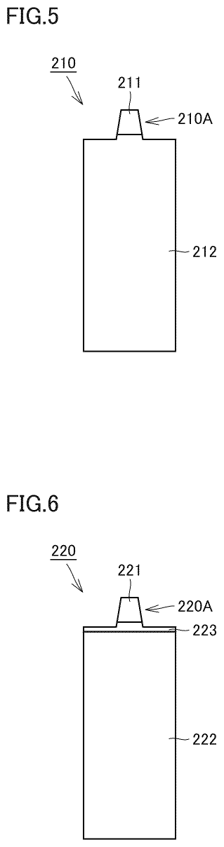

FIG. 5 is a front view showing negative electrode plate 210. As shown in FIG. 5, a negative electrode tab 211 constituted of a negative electrode core body is provided at one end portion of negative electrode plate 210. When negative electrode plates 210 are stacked, negative electrode tabs 211 are stacked to form negative electrode tab group 210A. In a portion corresponding to the main body portion of electrode assembly 200, a negative electrode active material layer 212 is provided on negative electrode plate 210.

FIG. 6 is a front view showing positive electrode plate 220. As shown in FIG. 6, a positive electrode tab 221 constituted of a positive electrode core body is provided at one end portion of positive electrode plate 220. When positive electrode plates 220 are stacked, positive electrode tabs 221 are stacked to form positive electrode tab group 220A. In a portion corresponding to the main body portion of electrode assembly 200, a positive electrode active material layer 222 is provided on positive electrode plate 220. A positive electrode protective layer 223 is provided at the root of positive electrode tab 221. Positive electrode protective layer 223 may not be necessarily provided.

In the present embodiment, electrode assembly 200 is a stacked type electrode assembly in which the plurality of negative electrode plates 210 and the plurality of positive electrode plates 220 are alternately stacked with the separator (not shown) being interposed therebetween. It should be noted that electrode assembly 200 may be a wound type electrode assembly in which an elongated negative electrode plate and an elongated positive electrode plate are wound.

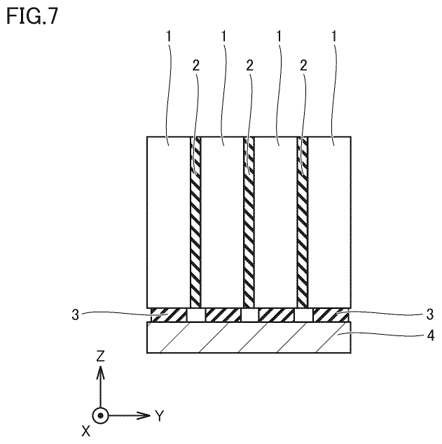

FIG. 7 is a diagram showing a configuration of a battery module including secondary battery 1. As shown in FIG. 7, the battery module includes a plurality of secondary batteries 1, separators 2, a heat transfer layer 3, and a temperature control member 4. The plurality of secondary batteries 1 and separators 2 are alternately arranged side by side in the Y direction.

Heat transfer layer 3 is disposed to be sandwiched between each of secondary batteries 1 and temperature control member 4 in the Z direction. The thickness of heat transfer layer 3 is, for example, about 1 mm or more and is preferably about 5 mm or less. Heat transfer layer 3 is a layer composed of a heat transfer material such as a urethane-based resin. A heat transfer coefficient of the heat transfer material is, for example, about 3 W/mK or more and is preferably about 5 W/mK or less.

Heat transfer layer 3 may be formed by applying an adhesive agent, which is composed of a heat transfer material, to the bottom portion of secondary battery 1, may be formed by attaching an adhesive tape, which is composed of a heat transfer material, to the bottom portion of secondary battery 1, or may be formed by placing a sheet material, which is composed of a heat transfer material, on the bottom portion of secondary battery 1. Heat transfer layer 3 does not necessarily need to be adhered to case 100 of secondary battery 1.

Heat generated in secondary battery 1 is transferred to temperature control member 4 via heat transfer layer 3. Temperature control member 4 can control the temperature of secondary battery 1 by promoting heat dissipation or cooling. Temperature control member 4 can be constituted of a plate-shaped member composed of a metal such as copper or aluminum. A passage may be provided inside temperature control member 4, and a cooling medium may be caused to flow in the passage.

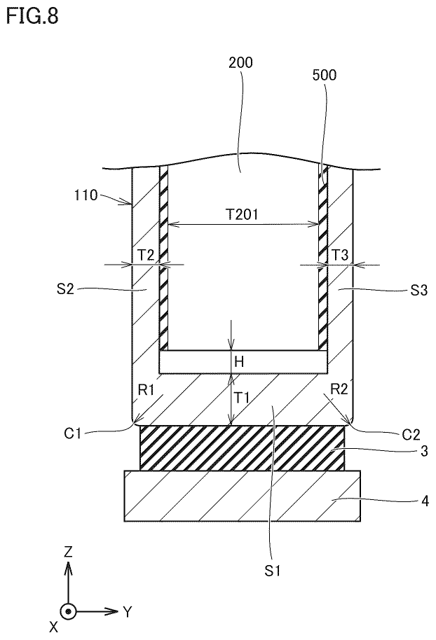

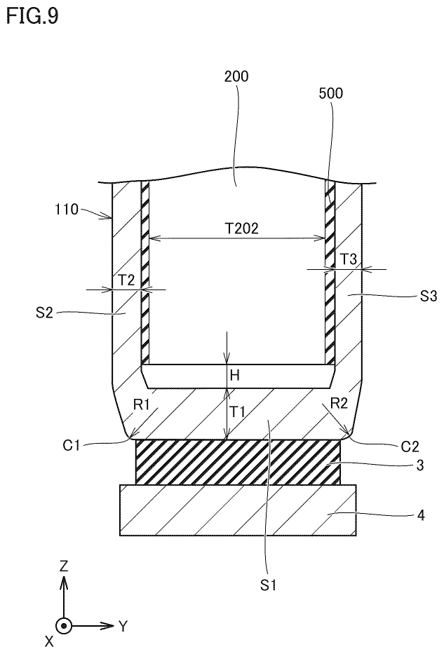

FIG. 8 is a cross sectional view showing a bottom portion of case main body 110 in a first state of secondary battery 1. FIG. 9 is a cross sectional view showing the bottom portion of case main body 110 in a second state of secondary battery 1. Here, the “first state” corresponds to a discharged state (for example, SOC: 0%) or initial state of secondary battery 1, and the “second state” corresponds to a charged state (for example, SOC: about 100%) or deteriorated state of secondary battery 1.

As shown in FIGS. 8 and 9, case main body 110 includes a bottom surface S1 (first surface) and a pair of long side surfaces S2, S3 (second surface and third surface). Electrode assembly 200 is accommodated in case main body 110 together with an electrode assembly holder 500.

Bottom surface S1 extends in a direction orthogonal to the Z direction. Bottom surface S1 preferably has a width (dimension) of about 30 mm or more (more preferably about 35 mm or more, and further preferably about 40 mm or more) in the Y direction. Bottom surface S1 preferably has a width (dimension) of about 300 mm or more (more preferably about 350 mm or more, and further preferably about 400 mm or more) in the X direction.

At least a portion of bottom surface S1 is in contact with heat transfer layer 3. Long side surfaces S2, S3 extend in a direction orthogonal to bottom surface S1. Long side surfaces S2, S3 extend parallel to each other and face each other in the Y direction.

Bottom surface S1 has a thickness T1 (first plate thickness), long side surface S2 has a thickness T2 (second plate thickness), and long side surface S3 has a thickness T3 (third plate thickness). In the example shown in FIGS. 8 and 9, thickness T1 of bottom surface S1 is larger than each of thicknesses T2, T3 of long side surfaces S2, S3, and thicknesses T2, T3 of long side surfaces S2, S3 are substantially equal to each other.

Thickness T1 of bottom surface S1 is more preferably about 1.3 times or more, and further preferably about 1.5 times or more as large as each of thicknesses T2, T3 of long side surfaces S2, S3. Thickness T1 of bottom surface S1 is preferably smaller than a thickness twice as large as each of thicknesses T2, T3 of long side surfaces S2, S3, is more preferably smaller than a thickness 1.9 times as large as each of thicknesses T2, T3 of long side surfaces S2, S3, and is further preferably smaller than a thickness 1.8 times as large as each of thicknesses T2, T3 of long side surfaces S2, S3.

Specifically, thickness T1 of bottom surface S1 is preferably 3.3% or more of the width (entire width including the curvature portion) of bottom surface S1 in the Y direction. Each of thicknesses T2, T3 of long side surfaces S2, S3 is preferably less than 2.0% of the width (entire width including the curvature portion) of bottom surface S1 in the Y direction.

As an example, when the width of bottom surface S1 in the Y direction is about 30 mm, thickness T1 of bottom surface S1 is larger than about 1.0 mm, and each of thicknesses T2, T3 of long side surfaces S2, S3 is smaller than 0.7 mm.

However, the relation among thicknesses T1, T2, T3 is not limited to the above range. For example, thicknesses T1, T2, T3 may be equal to one another.

Moreover, in the example of FIGS. 8 and 9, the structure in which bottom surface S1 and long side surfaces S2, S3 having different thicknesses from one another are constituted of a single member is shown; however, the scope of the present technology is not limited thereto, and for example, thickness T1 (first plate thickness) of bottom surface S1 may be made larger than thickness T2 (second plate thickness) of long side surface S2 by forming the outer portion of bottom surface S1 in one piece with long side surfaces S2, S3 and arranging a plate-shaped member as a different member so as to be internal thereto.

In the state (first state) shown in FIG. 8, electrode assembly 200 has a thickness T201 (first thickness) in the Y direction. In the state (second state) shown in FIG. 9, electrode assembly 200 has a thickness T202 (second thickness) in the Y direction.

In the state shown in FIG. 9, electrode assembly 200 is expanded in response to charging or deterioration. As a result, thickness T202 of electrode assembly 200 shown in FIG. 9 is larger than thickness T201 of electrode assembly 200 shown in FIG. 8.

Specifically, thickness T202 is preferably larger than thickness T201 by about 1.5% or more of the width (entire width including the curvature portion) of bottom surface S1 in the Y direction. Thickness T202 is preferably larger than thickness T201 by about 10% or less (more preferably about 5% or less) of the width of bottom surface S1 in the Y direction.

As an example, for example, when the width of bottom surface S1 in the Y direction is about 30 mm, an amount of expansion of electrode assembly 200 in the fully charged state with respect to the discharged state is about 0.5 mm.

A corner portion C1 (first corner portion) is provided at the outer surface of case main body 110 located between bottom surface S1 and long side surface S2, and a corner portion C2 (second corner portion) is provided at the outer surface of case main body 110 located between bottom surface S1 and long side surface S3.

Each of corner portions C1, C2 has a shape with a curvature. Corner portion C1 has a curvature radius R1 (first curvature radius), and corner portion C2 has a curvature radius R2 (second curvature radius). In the present embodiment, each of curvature radii R1, R2 is about 0.5 mm or less. Each of curvature radii R1, R2 is preferably about 0.2% or more (more preferably about 0.25% or more, and further preferably about 0.3% or more) of the width (entire width including the curvature portion) of bottom surface S1 in the Y direction.

The inner surface of bottom surface S1 and electrode assembly 200 are separated from each other by a distance H (separation distance) in the Z direction. Distance H is preferably about 30% or more of thickness T1 of bottom surface S1 of case main body 110. However, the separation distance between bottom surface S1 and electrode assembly 200 is not limited to the above range.

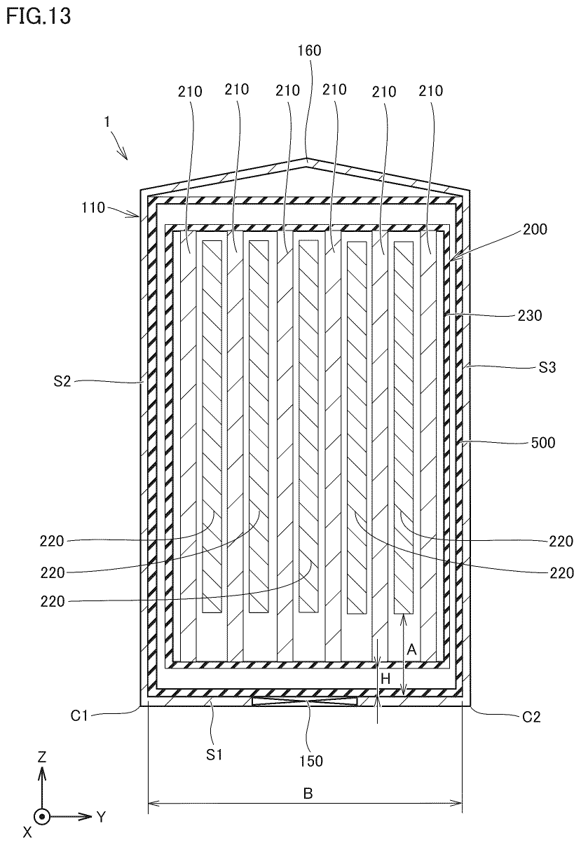

It should be noted that distance H (distance between the inner surface of bottom surface S1 and electrode assembly 200 in the Z direction) shown in each of FIGS. 8 and 9 corresponds to distance H between the inner surface of bottom surface S1 and the lower surface of separator 230 as shown in FIG. 13 described later.

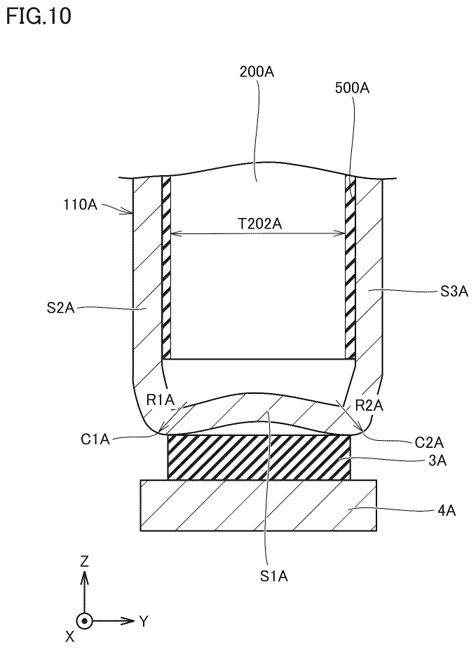

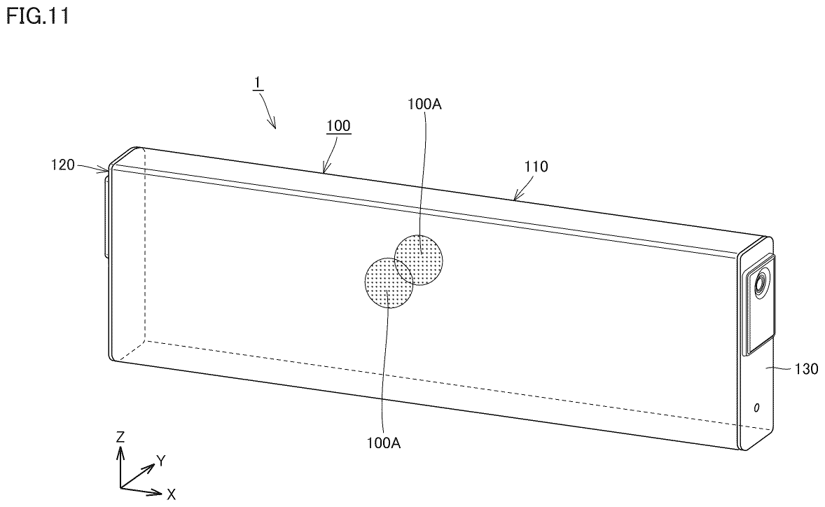

FIG. 10 is a cross sectional view showing a bottom portion of a case main body 110A in a secondary battery according to a comparative example. FIG. 10 shows a state (second state) in which an electrode assembly 200A is expanded to have a thickness T202A. Heat generated in the secondary battery is transferred to a temperature control member 4A via a heat transfer layer 3A.

In the comparative example shown in FIG. 10, a bottom surface S1A and a pair of long side surfaces S2A, S3A have substantially the same thickness. In the comparative example shown in FIG. 10, since the thickness of bottom surface S1A is merely comparable to that of each of long side surfaces S2A, S3A, bottom surface S1A is likely to be deformed in response to the expansion of electrode assembly 200A as compared with secondary battery 1 shown in FIGS. 8 and 9.

Moreover, in the comparative example shown in FIG. 10, curvature radii R1A, R2A of corner portions C1A, C2A located at both ends of bottom surface S1A are larger than curvature radii R1, R2 shown in FIGS. 8 and 9 (for example, about 1 mm). Therefore, a contact area between bottom surface S1A of case main body 110A and heat transfer layer 3A becomes relatively small.

As a result, in the comparative example shown in FIG. 10, a clearance is likely to be formed between bottom surface S1A of case main body 110A and heat transfer layer 3A as compared with secondary battery 1 shown in FIGS. 8 and 9.

On the other hand, since thickness T1 of bottom surface S1 is larger than each of thicknesses T2, T3 of long side surfaces S2, S3 in secondary battery 1 shown in FIGS. 8 and 9, deformation of bottom surface S1 can be suppressed, and a clearance between bottom surface S1 of case main body 110 and heat transfer layer 3 can be suppressed from being formed even when electrode assembly 200 is expanded, as shown in FIGS. 8 and 9.

Moreover, since each of curvature radii R1, R2 of corner portions C1, C2 located at both ends of bottom surface S1 is about 0.5 mm or less in secondary battery 1 shown in FIGS. 8 and 9, the flat portion of bottom surface S1 can be formed to be relatively wide, thereby attaining a relatively large contact area between bottom surface S1 and heat transfer layer 3.

As described above, in secondary battery 1 according to the present embodiment, it is possible to suppress formation of a clearance between bottom surface S1 of case main body 110 and heat transfer layer 3 and it is possible to attain a relatively large contact area between bottom surface S1 and heat transfer layer 3. As a result, efficient temperature control can be performed in the secondary battery module.

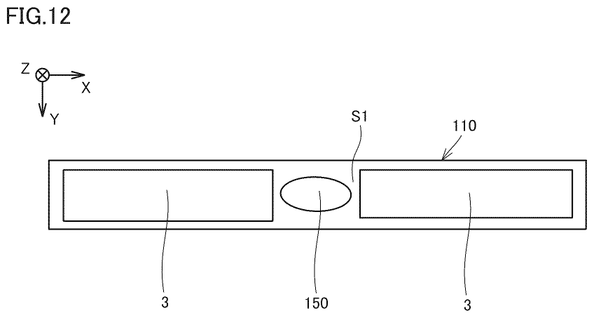

Next, a method of calculating the thickness of electrode assembly 200 will be described with reference to FIG. 11. Each of thicknesses T201, T202 shown in FIGS. 8 and 9 is a value obtained by subtracting a thickness (for example, the thickness of case 100×2+electrode assembly holder 500×2=0.65 mm×2+0.15 mm×2) corresponding to a member other than electrode assembly 200 from the thickness (dimension in the Y direction) of case 100 when a predetermined pressing region 100A including the geometric center of each of the pair of long side surfaces of case 100 (for example, a circular region having an area of 10 cm² and centered on the geometric center) is pressed along the Y direction with a predetermined load (for example, 180N).

FIG. 12 is a diagram showing the arrangements of heat transfer layer 3 and a gas-discharge valve 150 at bottom surface S1 of case 100. As shown in FIG. 12, gas-discharge valve 150 is provided in bottom surface S1 of case 100. Gas-discharge valve 150 is preferentially fractured when pressure in case 100 becomes equal to or higher than a predetermined value, and discharges the gas in case 100 to the outside.

Bottom surface S1 has a region (first region) in contact with heat transfer layer 3 and a region (second region) in which heat transfer layer 3 is not disposed. Gas-discharge valve 150 is provided in the region in which heat transfer layer 3 is not disposed.

A range in which heat transfer layer 3 is provided can be appropriately changed, but is preferably disposed at a position including the center of bottom surface S1 in the Y direction. Heat transfer layer 3 preferably has an area of about 20% or more of the area of the flat portion of bottom surface S1. When gas-discharge valve 150 is not provided in bottom surface S1, heat transfer layer 3 may be provided on the entire flat portion of bottom surface S1.

FIG. 13 is a cross sectional view showing the structure of electrode assembly 200 and the arrangement of gas-discharge valve 150. In FIG. 13, for convenience of illustration, separator 230 is illustrated to be only external to negative electrode plate 210 and positive electrode plate 220, but separator 230 is also provided between negative electrode plate 210 and positive electrode plate 220. The respective numbers of stacked negative electrode plates 210 and stacked positive electrode plates 220 shown in FIG. 13 are merely exemplary, and can be appropriately changed.

As shown in FIG. 13, the end portion of positive electrode plate 220 located on the side close to bottom surface S1 (lower side in the figure) and the inner surface of bottom surface S1 are separated from each other by a distance A (first distance) in the Z direction. Moreover, in a boundary portion (corner portions C1, C2) with bottom surface S1, the inner surface of long side surface S2 and the inner surface of long side surface S3 are separated from each other by a distance B (second distance) in the Y direction.

Here, distance A is preferably larger than about 20% or more (more preferably about 30% or more, and further preferably about 50% or more) of distance B.

Thus, by increasing the distance from bottom surface S1 of case 100 to electrode assembly 200, deformation of bottom surface S1 when electrode assembly 200 is expanded can be suppressed, and formation of a clearance between bottom surface S1 and heat transfer layer 3 can be suppressed. As a result, efficient temperature control can be performed in the secondary battery module.

The inventor of the present technology has confirmed that with distance A being about 20% of distance B, an amount of deformation of bottom surface S1 of case 100 can be reduced to about ⅓ of that in the case where distance A is about 7% of distance B. Further, the inventor of the present technology has confirmed that with distance A being about 60% of distance B, the amount of deformation of bottom surface S1 of case 100 can be reduced to about ⅓ of that in the case where distance A is about 20% of distance B.

In response to charging/discharging of secondary battery 1, gas is generated in case 100 to increase the internal pressure of case 100, with the result that a top portion 160 of case 100 is deformed to be expanded outward as shown in FIG. 13, for example.

In secondary battery 1 shown in FIG. 13, since the distance from bottom surface S1 of case 100 to electrode assembly 200 is large, gas is likely to be accumulated also at the bottom portion of case 100. Therefore, when the internal pressure of case 100 is increased, gas-discharge valve 150 provided in bottom surface S1 can be stably operated to suppress the internal pressure of case 100 from being increased excessively. As a result, it is possible to suppress the gas or a content from being blown off from an unintended location of case 100.

In secondary battery 1 according to the present embodiment, as described above, the deformation of bottom surface S1 of case 100 is suppressed. Therefore, gas-discharge valve 150 provided in bottom surface S1 can be stably operated.

FIG. 13 illustratively shows electrode assembly 200, which is the stacked type electrode assembly; however, the same concept as that in FIG. 13 can be employed also in the case of the wound type electrode assembly. In this case, distance A between the lower end (portion closest to bottom surface S1) of the positive electrode in the wound type electrode assembly and the inner surface of bottom surface S1 is preferably larger than about 20% or more (more preferably about 30% or more, and further preferably about 50% or more) of distance B between the inner surface of long side surface S2 and the inner surface of long side surface S3.

In the example of FIG. 13, all the heights (positions in the Z direction) of the lower ends of the plurality of positive electrode plates 220 coincide with one another, but the scope of the present technology is not limited thereto, and for example, the heights of the lower ends of parts of positive electrode plates 220 may be different. When the heights of the lower ends of the plurality of positive electrode plates 220 are different from one another, the average value of the distances between the lower ends of the plurality of positive electrode plates 220 and the inner surface of bottom surface S1 is defined as distance A (first distance) between the end portion of positive electrode plate 220 and the inner surface of bottom surface S1.

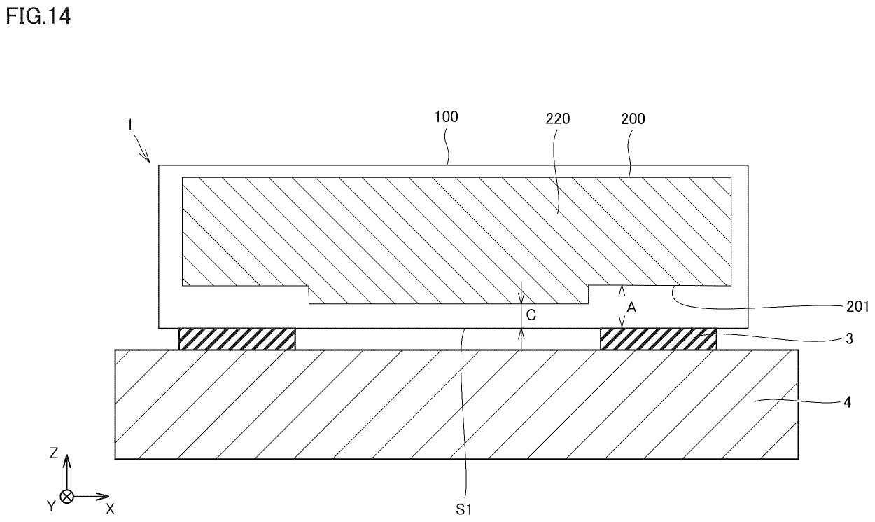

FIG. 14 is a front cross sectional view of a battery module according to a modification. As shown in FIG. 14, a cutout portion 201 may be provided in a portion of electrode assembly 200, and the separation distance from bottom surface S1 of case 100 to the lower end portion of positive electrode plate 220 may be varied in the X direction.

In the example shown in FIG. 14, the inner surface of bottom surface S1 and the end portion of positive electrode plate 220 are separated from each other by distance A (first distance) in the Z direction in the region (first region) in which bottom surface S1 of case 100 is in contact with heat transfer layer 3, and the inner surface of bottom surface S1 and the end portion of positive electrode plate 220 are separated from each other by a distance C (third distance) smaller than distance A in the Z direction in the region (second region) in which heat transfer layer 3 is not disposed. For example, when the width of bottom surface S1 in the Y direction is about 30 mm, distance A is preferably about 6 mm or more, and distance C is preferably about less than 2 mm.

According to the modification shown in FIG. 14, in the region in which bottom surface S1 of case 100 is in contact with heat transfer layer 3, electrode assembly 200 is separated far away from bottom surface S1, thereby suppressing bottom surface S1 from being deformed due to expansion of electrode assembly 200. On the other hand, in the region in which heat transfer layer 3 is not disposed, the region of electrode assembly 200 can be increased by providing electrode assembly 200 to reach a position close to bottom surface S1. As a result, in the secondary battery module, efficient temperature control can be performed and energy density can be improved.

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A secondary battery module comprising:
a plurality of batteries each including an electrode assembly and a case that accommodates the electrode assembly, the case having a prismatic shape, the plurality of batteries being arranged in a first direction;
a temperature control member that controls a temperature of each of the plurality of batteries; and
a heat transfer layer sandwiched between each of the plurality of batteries and the temperature control member in a second direction orthogonal to the first direction, wherein
the case has
a first surface extending in a direction orthogonal to the second direction, having at least a portion in contact with the heat transfer layer, and having a first plate thickness,
a second surface extending in a direction orthogonal to the first surface and having a second plate thickness,
a third surface extending parallel to the second surface and facing the second surface in the first direction,
a first corner portion provided between the first surface and the second surface in an outer surface of the case, and
a second corner portion provided between the first surface and the third surface in the outer surface of the case,
in a first state of each of the plurality of batteries, the electrode assembly has a first thickness in the first direction, and in a second state of each of the plurality of batteries, the electrode assembly has a second thickness in the first direction, and the second thickness is larger than the first thickness by a thickness of 1.5% or more of a dimension of the first surface in the first direction,
the first plate thickness of the case is larger than the second plate thickness, and
the first corner portion of the case has a first curvature radius, the second corner portion has a second curvature radius, and each of the first curvature radius and the second curvature radius is 0.5 mm or less.

2. The secondary battery module according to claim 1, wherein the first plate thickness is smaller than a thickness twice as large as the second plate thickness.

3. The secondary battery module according to claim 1, wherein an inner surface of the first surface and the electrode assembly are separated from each other by 30% or more of the first plate thickness in the second direction.

4. The secondary battery module according to claim 1, wherein
the case includes
a case main body having a tubular shape, the case main body including the first surface to the third surface, the case main body being provided with a first opening and a second opening at both ends in a third direction orthogonal to the first direction and the second direction, and
a first sealing plate and a second sealing plate that seal the first opening and the second opening respectively.

5. The secondary battery module according to claim 4, wherein the first surface of the case has a dimension of 300 mm or more in the third direction.

6. The secondary battery module according to claim 1, wherein the electrode assembly is a stacked type electrode assembly in which a positive electrode and a negative electrode are stacked with a separator being interposed between the positive electrode and the negative electrode.

7. The secondary battery module according to claim 1, wherein the heat transfer layer is disposed at a position including a center of the first surface in the first direction.

8. The secondary battery module according to claim 1, wherein each of the first curvature radius and the second curvature radius is 0.2% or more of the dimension of the first surface in the first direction.

9. The secondary battery module according to claim 1, wherein a gas-discharge valve is provided in the first surface of the case.

10. The secondary battery module according to claim 1, wherein
the first plate thickness is smaller than a thickness twice as large as the second plate thickness,
an inner surface of the first surface and the electrode assembly are separated from each other by 30% or more of the first plate thickness in the second direction,
the case includes
a case main body having a tubular shape, the case main body including the first surface to the third surface, the case main body being provided with a first opening and a second opening at both ends in a third direction orthogonal to the first direction and the second direction, and
a first sealing plate and a second sealing plate that seal the first opening and the second opening respectively,
the first surface of the case has a dimension of 300 mm or more in the third direction,
the electrode assembly is a stacked type electrode assembly in which a positive electrode and a negative electrode are stacked with a separator being interposed between the positive electrode and the negative electrode,
the heat transfer layer is disposed at a position including a center of the first surface in the first direction,
each of the first curvature radius and the second curvature radius is 0.2% or more of the dimension of the first surface in the first direction, and
a gas-discharge valve is provided in the first surface of the case.
